(19) United States
(12) Patent Application Publication
(10) Pub. No.: US 2008/0155974 A1
(43) Pub. Date: Jul. 3, 2008

(54) Power Plant for a Motor Vehicle

(75) Inventors: Heinz Aitzetmueller, St. Konrad (AT); Dieter Stoeckl, Steyr (AT); Reinhard Flachs, Wilhering (AT); Johann Paul Hofer, Girlan (IT); Markus Hofer, Garsten (AT)

Correspondence Address: CROWELL & MORING LLP;INTELLECTUAL PROPERTY GROUP, P.O. BOX 14300, WASHINGTON, DC, 20044-4300, US

(73) Assignee: Hofer Forschungs & Entwicklungs GmbH Co KG, Garsten (AT)

(21) Appl. No.: 11/875,463

(22) Filed: Oct. 19, 2007

(30) Foreign Application Priority Data
Oct. 24, 2006 (AT) A 1785/2006

(51) Int. Cl. F16H 39/00; F16D 31/00; F16H 55/17; F16H 1/28; F16F 15/00

(52) U.S. Cl. 60/325; 74/460; 60/487; 475/269; 74/572.2; 60/327

(57) ABSTRACT

An engine suitable for a motor vehicle, preferably a motorcycle, and a related transmission is provided. The transmission is provided with a hydrostatic device and a planetary transmission leading to a driven shaft. In order to optimize the engine with regard to construction and function the hydrostatic device of the transmission cooperating with the internal combustion engine is in an effective connection to the planetary transmission.

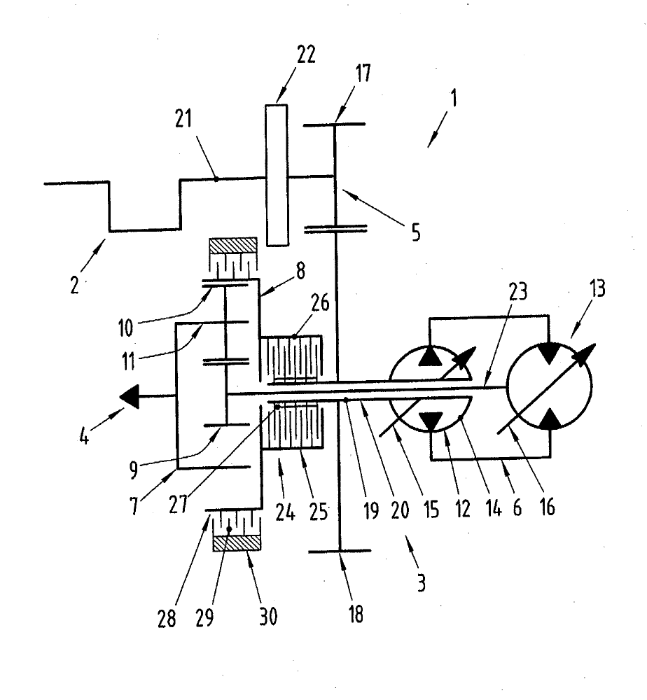

This application claims the priority of Austrian Patent Document A 1785/2006, filed Oct. 24, 2006, the disclosure of which is expressly incorporated by reference herein.

### BACKGROUND AND SUMMARY OF THE INVENTION

The invention relates to an engine for a motor vehicle and related transmission.

A motorcycle with a hydrostatic, constantly variable transmission is known from German Patent Document DE 39 04 045 C2, which comprises a swash plate hydraulic pump. The crankshaft of an internal combustion engine providing the drive for the motorcycle and the transmission are located in a common housing. The transmission has an input shaft and an output shaft arranged parallel in reference to the crankshaft. The crankshaft drives the input shaft via a primary rotation gear reduction, while the output shaft influences a rear wheel of the motorcycle with a secondary rotation gear reduction being interposed.

From German Patent Document DE 101 26 105 A1 an engine for a motorcycle is disclosed, which engine being provided with a motor unit and a transmission unit. In the transmission unit an input shaft and an output shaft are supported rotationally in a frontal and/or rear area of another housing, different from the housing of the motor block, in order to form a transmission device.

In German Patent Document DE 101 00 562 A1 a drive unit for a small vehicle is discussed, in which the drive unit and the transmission unit, coupled thereto in a pivotal manner, are installed. The drive unit is divided into three sections, namely a motor block, a transmission part, and a differential part. The transmission part is located in a transmission housing, in which a V-belt automatic transmission (rotation or speed regulation transmission) is arranged.

The object of the invention is to provide an engine for a motor vehicle, preferably a motorcycle, which is characterized in a good function while having a simple design.

The advantages primarily achieved by the invention are to be considered the excellent conditions for operating a motorcycle with said engine by the combination of the hydrostatic device and the planetary transmission connected to the internal combustion engine. Here, both the hydrostatic device and the planetary transmission represent technical systems, which can be further developed with the technical performance targeted for the intended use. This also applies to the spur gearing between the internal combustion engine and the hydrostatic device as well as the hydraulic pump and hydraulic motor components of said hydrostatic device. The exemplary function of the engine is additionally supported by the clutch and the brake and/or a suitable other fixing arrangement for the hollow wheel of the planetary transmission. Furthermore the engine is therefore well thought through, because based on the described components and/or their skilled cooperation a separate reverse gearing device can be omitted. Finally the disclosed method for operating the motorcycle sets new standards in the design of motor vehicles.

Other objects, advantages and novel features of the present invention will become apparent from the following detailed description of the invention when considered in conjunction with the accompanying drawings.

### BRIEF DESCRIPTION OF THE DRAWINGS

The drawing, comprising a single FIGURE, illustrates a schematic power plant for a motorcycle, which is explained in greater detail in the following.

### DETAILED DESCRIPTION

An engine 1 for a motorcycle, not shown, of a one-track or multi-track and/or light or heavy type, including such embodiments which are mobile on road and off-road, comprises an internal combustion engine 2 and a transmission 3. The transmission 3 leads to a drive shaft 4, driven by one or more wheels of the motorcycle. The internal combustion engine 2 cooperates with a hydrostatic device 6, with a power transmission unit embodied as a spur gearing 5 being interposed, which is in an effective connection to the planetary transmission 7 leading to the drive shaft 4.

The summarizing planetary transmission 7 is provided with a hollow wheel 8 and a sun wheel 9. Between the hollow wheel 8 and the sun wheel 9 at least one planetary wheel 10 is effective, which is held by a planetary carrier 11 connected to the drive shaft 4. The hydrostatic device 6 has a hydraulic pump 12 and a hydraulic motor 13. In the hydraulic pump 12 an adjustment device 15 is integrated, provided with an adjustment ring 14 that can be deflected, by which the displacement volume of the hydraulic pump 12 can be modified. The hydraulic motor 13 is provided with a second adjustment device 16, by which the volume of the intake of said hydraulic motor can be influenced.

The spur gearing 5 comprises a first toothed wheel 17 and a second toothed wheel 18, engaging the first toothed wheel 17 and cooperating with the hydraulic pump 12 with a first connection shaft 20 embodied as a hollow shaft 19 being interposed. Furthermore, between the first toothed wheel 17 and a crankshaft 21 of the internal combustion engine 2 an oscillation damper 22 is provided. The hydraulic motor 13 drives the sun wheel 9 of the planetary transmission 7 via a second connection crankshaft 23. Here, the second connection shaft 23 is aligned coaxially in reference to the first connection shaft 20, and the first connection shaft 20 surrounds the second connection shaft 23 at least partially.

A clutch 24 is provided between the hollow shaft 20 and the hollow wheel 8, preferably of the type of multi-disc friction coupling 25. The latter is embodied as a power shift gear and provided with a basket 26 carrying friction discs and a hub 27 accepting friction discs. The clutch 24 and/or multi-disc friction coupling 25 is connected, on the one hand, to a first connection shaft 20 and, on the other hand, a cooperating hollow wheel 8 of the planetary transmission 7. More precisely, the basket 26 is structurally united with the hollow wheel 8; the hub 27 with the first connection shaft 20. For the rest, the hollow wheel 8 is provided with a brake 29 at its exterior 28, which is supported at a fixed housing 30. Instead of the brake 29, a form-fitting connection e.g., a link may also be used to fix the hollow wheel 8.

In an operating internal combustion engine 2 the hollow shaft 20 rotates according to the transmission ratio in the spur gearing 5. Here, when the motorcycle is stationary, the rotation of the drive shaft 4 is zero. The clutch 24 is open and the hydraulic pump 12 is driven via the hollow shaft 20. By deflecting the adjustment ring 14 the hydraulic pump 12 is adjusted such that the hydraulic motor 13 and the sun wheel 9 connected to the latter rotate opposite in reference to the direction of rotation of the hollow shaft 19. Here the drive shaft 4 is idling, because the hollow wheel 8 of the planetary transmission 7 transmits no torque.

By closing the clutch 24 the hollow shaft 19 is connected to the hollow wheel 8 and the transmission of force is enabled. The start of the motorcycle occurs via a slipping clutch 24. In order to ensure a targeted, soft acceleration the internal combustion engine 2 is operated with low rotations. After the coupling process is completed a continuous adjustment of the transmission ratio is possible by changing the displacement volume of the hydraulic pump 12. The rotation of the sun wheel 9 is here reduced from a maximum rotation in the opposite direction in reference to the hollow wheel 8 to a rotation of zero and then is once more accelerated in the same direction of rotation as the hollow wheel 8 up to maximum rotation. This way, after the coupling process, a constant acceleration of the motorcycle can be achieved up to the maximum speed by changing the rotation of the sun wheel 9.

Thanks to the adjustable hydraulic motor 13 with the variable intake volume there is the additional chance to increase the entire range of the transmission even more. In a given displacement volume of the hydraulic pump 12 the rotation of the sun wheel 9 is increased by a reduction of the intake volume and the operational rotation is further increased.

In case of critical driving conditions of the motorcycle the drive train can be interrupted by opening the clutch 24.

Motorcycles with the appropriate technical embodiment can also be moved backwards. This is achieved in the present embodiment such that the hollow wheel 8 of the planetary transmission 7 is blocked in reference to the housing 30. Here, the sun wheel 9 is connected to the hydraulic motor 13, with the sun wheel 9 being driven by changing the displacement volume at the hydraulic pump 12 such that the motorcycle can be driven forward and backward at low speeds.

The foregoing disclosure has been set forth merely to illustrate the invention and is not intended to be limiting. Since modification of the disclosed embodiments incorporating the spirit and substance of the invention may occur to persons skilled in the art, the invention should be construed to include everything within the scope of the appended claims and equivalents thereof.

What is claimed is:

1. An engine for a motor vehicle, comprising:
an internal combustion engine; and
a transmission provided with a hydrostatic device which leads to a drive shaft,
wherein the hydrostatic device of the transmission cooperates with the internal combustion engine to transfer torque from the engine to the drive shaft to drive the motorcycle.

2. The engine according to claim 1, further comprising:
a power transmission unit arranged to transfer torque between the internal combustion engine and the hydrostatic device,
wherein the power transmission unit is a spur gearing.

3. The engine according to claim 2, wherein the hydrostatic device comprises a hydraulic pump and a hydraulic motor.

4. The engine according to claim 3, wherein a displacement volume of the hydraulic pump can be adjusted.

5. The engine according to claim 3, wherein an intake volume of the hydraulic motor is constant or adjustable.

6. The engine according to claim 3, wherein a second toothed wheel of the spur gearing engages a first toothed wheel, and the second toothed wheel cooperates with the hydraulic pump via a first connection shaft.

7. The engine according to claim 6, wherein the first connection shaft is a hollow shaft.

8. The engine according to claim 3, wherein transmission includes a planetary transmission, and the hydraulic motor drives a sun wheel of the planetary transmission via a second connection shaft.

9. The engine according to claim 8, wherein the second connection shaft extends coaxially with the hollow shaft.

10. The engine according to claim 9, wherein the hollow shaft surrounds the second connection shaft at least partially.

11. The engine according to claim 3, further comprising:
a clutch provided between the hollow shaft and the planetary transmission.

12. The engine according to claim 11, wherein the clutch is a friction coupling.

13. The engine according to claim 11, wherein the clutch is a multi-disc friction coupling.

14. The engine according to claim 11, wherein the clutch is coupled to the hollow shaft and to a hollow wheel of the planetary transmission.

15. The engine according to claim 6, wherein an oscillation damper is interposed between the first toothed wheel of the spur gearing and the internal combustion engine.

16. A method to operate an engine in a motorcycle having an internal combustion engine and a transmission provided with a hydrostatic device which leads to a drive shaft, the hydrostatic device comprising a hydraulic pump and a hydraulic motor, a power transmission unit arranged to transfer torque between the internal combustion engine and the hydrostatic device wherein the power transmission unit is a spur gearing, a second toothed wheel of the spur gearing engages a first toothed wheel and the second toothed wheel cooperates with the hydraulic pump via a first connection shaft, the hydraulic motor drives a sun wheel of the planetary transmission via a second connection shaft, and a clutch provided between the hollow shaft and the planetary transmission, comprising the steps of:
using the internal combustion engine to rotate the hollow shaft and thereby rotate and drive the hydraulic pump;
operating the clutch such that
when starting the motorcycle the clutch is open, with the hydraulic motor and the sun wheel rotating opposite a direction of rotation of the hollow shaft when a adjustment ring of the hydraulic pump is adjusted to drive the hydraulic pump, and
when the clutch is closed, the hollow shaft is connected to the hollow wheel and power is transmitted to the drive shaft to drive the motorcycle.

17. The method according to claim 16, wherein the initial movement of the motorcycle occurs by slipping of the clutch.

18. The method according to claim 17, wherein the internal combustion engine is operated with a relatively low rotation for starting the motorcycle.

19. The method according to claim 17, further comprising the step of:
when the clutch is closed, adjusting a transmission ratio through the planetary transmission by adjusting a displacement volume of the hydraulic pump, such that the rotation of the sun wheel is reduced from a maximum rotation rate opposite to the hollow wheel when the clutch is open to a rotation rate of zero and then to a maximum rotation rate in the direction of rotation the hollow wheel.

20. The method according to claim 16, further comprising, for operating the motor vehicle for a forward or backward driving, the steps of:
fixing the hollow wheel with a fixation device such that the hollow wheel is held stationary relative to a fixed housing of the motorcycle,; and
moving the motorcycle forward and/or backward by adjusting the displacement stream of the hydraulic pump such that the sun wheel cooperates with the hydraulic motor of the hydrostatic device via the second connection shaft to drive the drive shaft in the forward and/or backward rotation direction.
